(19) United States
(12) Patent Application Publication
(10) Pub. No.: US 2025/0305955 A1
(43) Pub. Date: Oct. 2, 2025

(54) MEASUREMENT SYSTEM AND MEASUREMENT METHOD

(71) Applicants: Fujirebio Inc., Tokyo (JP); Fluxus, Inc., Sunnyvale, CA (US)

(72) Inventors: Masayasu IMAIZUMI, Tokyo (JP); Kazushige MORIYAMA, Tokyo (JP); Joshua Wayne PARKS, Sunnyvale, CA (US)

(73) Assignees: Fujirebio Inc., Tokyo (JP); Fluxus, Inc., Sunnyvale, CA (US)

(21) Appl. No.: 18/619,388

(22) Filed: Mar. 28, 2024

(51) Int. Cl. G01N 21/64

(52) U.S. Cl. CPC G01N 21/645; G01N 2021/6463; G01N 2201/1242

(57) ABSTRACT

A measurement system comprises a light source configured to irradiate excitation light to a fluorescent substance kept in a sample container, the sample container containing a sample comprising the fluorescent substance, a detector configured to detect radiated light emitted from the fluorescent substance depending on the excitation light, a measurement device configured to measure a concentration of the fluorescent substance based on a detection signal detected by the detector, and a washing device configured to supply washing liquid for washing the sample container to the sample container, and the measurement device comprises a first determination unit configured to execute a first determination process. A first measurement unit is configured to execute an analog measurement and a second measurement unit is configured to execute a digital measurement.

### BACKGROUND

### Technical Field

The present invention relates to measurement systems and measurement methods.

A technique is known of analyzing a fluorescently labeled entity contained in a sample in a sample container, depending on radiated light emitted from a fluorescent substance in the fluorescently labeled entity when excitation light is irradiated to the fluorescent substance (for example, see patent literature 1).

### CITATION LIST

### Patent Literature

[Patent literature 1] Japanese Unexamined Patent Application Publication (Translation of PCT Application) No. 2014-504154.

### Technical Problem

The sample container has to be washed out after every analysis when a plurality of samples is successively analyzed using only the sample container. However, the washing time of the unit is generally constant. For this reason, the insufficient washing time often makes the washing of the sample container insufficient, especially when a sample with a high concentration of fluorescent substance is analyzed.

The present invention has been made in view of the foregoing problem. An object of the present invention is to provide a measurement system capable of washing the sample container for an appropriate washing time, depending on the concentration of the fluorescent substance.

### SUMMARY

An invention for achieving the foregoing objective is a measurement system comprises a light source configured to irradiate excitation light to a fluorescent substance kept in a sample container, the sample container containing a sample comprising the fluorescent substance, a detector configured to detect radiated light emitted from the fluorescent substance depending on the excitation light, a measurement device configured to measure a concentration of the fluorescent substance based on a detection signal detected by the detector, and a washing device configured to supply washing liquid for washing the sample container to the sample container, and the measurement device comprises a first determination unit configured to execute a first determination process, the first determination process determining whether a first value of intensity of the detection signal detected under a first condition is within a first range, a first measurement unit configured to execute an analog measurement, in which a first measurement process measuring a concentration of the fluorescent substance contained in the sample is performed when the first value of intensity is within the first range, a second measurement unit configured to execute a digital measurement, in which a second measurement process measuring a concentration of the fluorescent substance contained in the sample is performed when the first value of intensity is determined to be lower than a lower limit of the first range, and a first control unit configured to control the washing device such that the sample container is washed for a first washing time period when the first measurement process is performed and the sample container is washed for a second washing time period when the second measurement process is performed.

Furthermore, a measurement method executed by a measurement system, the measurement system comprises a light source configured to irradiate excitation light to a fluorescent substance kept in a sample container, the sample container containing a sample comprising the fluorescent substance, a detector configured to detect radiated light emitted from the fluorescent substance depending on the excitation light, a measurement device configured to measure a concentration of the fluorescent substance based on a detection signal detected by the detector; and a washing device configured to supply washing liquid for washing the sample container to the sample container, and the measurement device comprises a step for executing a first determination process, the determination process determining whether a first value of intensity of the detection signal detected under a first condition is within a first range, a step for executing an analog measurement, in which a first measurement process measuring a concentration of the fluorescent substance contained in the sample is performed when the first value of intensity is within the first range, a step for executing a digital measurement, in which a second measurement process measuring a concentration of the fluorescent substance contained in the sample is performed when the first value of intensity is determined to be lower than a lower limit of the first range, and a step for controlling the washing device such that the sample container is washed for a first washing time period when the first measurement process is executed and the sample container is washed for a second washing time period when the second measurement process is executed. Other features of the present invention will become apparent from the description of this specification.

### Advantageous Effect of the Invention

According to the present invention, it is possible to provide a measurement system capable of washing a sample container for an appropriate washing time, depending on a concentration of a fluorescent substance.

### BRIEF DESCRIPTION OF DRAWINGS

FIG. 1 illustrates an example of a measurement system 1a.

FIG. 2 illustrates an analog process and a digital process.

FIG. 3 illustrates a hardware configuration of measurement devices 60a, 60b, and 60c.

FIG. 4 illustrates function blocks of the measurement device 60a.

FIG. 5 illustrates a flowchart of a process executed by the measurement device 60a.

FIG. 6 illustrates an example of a measurement system 1b.

FIG. 7 illustrates an example of a measurement system 1c.

FIG. 8 illustrates an example of a measurement system 1d.

### DETAILED DESCRIPTION

### The First Embodiment

<<Measurement System 1a>>

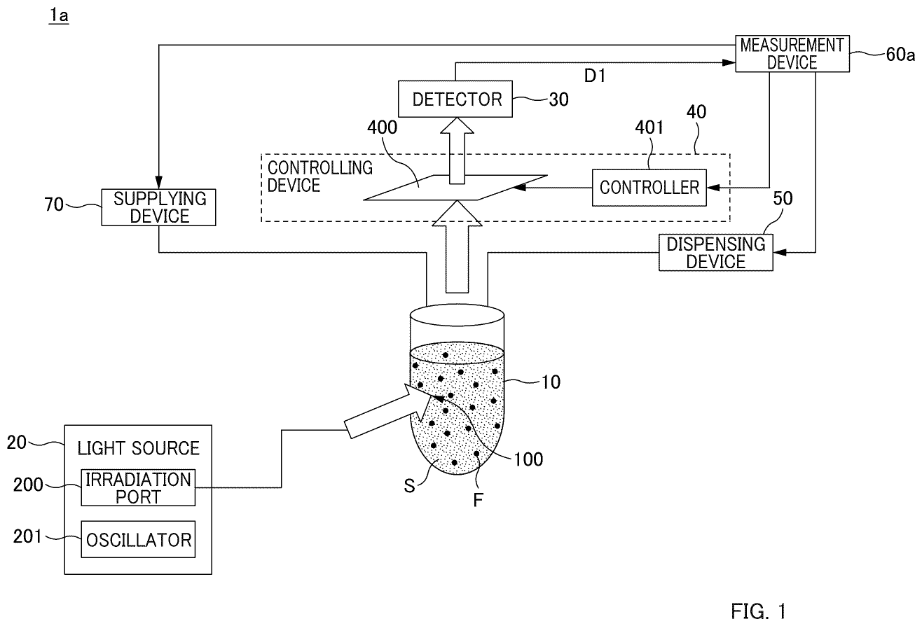

FIG. 1 illustrates a measurement system 1a of the present embodiment. The measurement system 1a a system for measuring a concentration of a fluorescent substance F contained in a specified sample S.

Sample S is a material to be measured or analyzed, and is a liquid that contains a fluorescently labeled entity and a solvent (water, saline solution, oil, alcohol, buffer solution, for example). The fluorescently labeled entity is a substance as a marker when analyzing a test substance, and a fluorescent substance is directly or indirectly conjugated to, for example, antigens, antibodies, nucleic acids, biomolecules, low molecular weight compounds, hormones, polypeptides, and proteins in the fluorescently labeled entity. Sample S can be, for example, fluorescently labeled antibody solution, fluorescently labeled antigen solution, fluorescently labeled nucleic acid solution, fluorescently labeled polypeptide solution, and fluorescently labeled protein solution.

Fluorescent substance F is in the foregoing fluorescently labeled entity. A fluorescent substance contained in a fluorescently labeled entity is, for example, a low molecular weight compound including europium complex, fluorescein isothiocyanate (FITC), rhodamine isothiocyanate (RITC), sulfonated cyanine, and a fluorescent protein including allophycocyanin (APC) and phycoerythrin (R-PE). Alternatively, the fluorescent substance F can be a fluorescent substance not conjugated to a labeled entity.

The measurement system 1a comprises a sample container 10, a light source 20, a detector 30, a controlling device 40, a dispensing device 50, a measurement device 60a, and a washing device 70.

### <Sample Container 10>

The sample container 10 is a member for holding a sample S to be measured (hereinafter also simply referred to as “sample S”) in the measurement of a concentration of the fluorescent substance F (hereinafter also simply referred to as “concentration”).

The sample container 10 of the present embodiment is a vessel-shaped member. An excitation light from the light source 20 reaches at least a part of the area 100 of an inner part of the sample container 10 (described later).

The shape of the sample container 10 is not limited to this embodiment. The sample container 10 may have any shape, so long as the excitation light emitted from the light source 20 can be irradiated to at least a part of the sample S in the sample container 10. Other shape examples of the sample container 10 may also be a cube, channel (described later), or the like.

### <Light Source 20>

The light source 20 is device that irradiates the excitation light to the fluorescent substance F contained in the sample S (hereinafter also simply referred to as “fluorescent substance F”), kept in the sample container 10. The light source 20 includes an oscillator 201 that oscillates the excitation light, and an irradiation port 200 for emitting the excitation light.

The excitation light reaches the sample container 10, and is partially absorbed by the fluorescent substance F. The fluorescent substance F in a ground state changes into an excited state by absorbing the excitation light. The fluorescent substance F in the excited state emits light (radiated light), and is back to the ground state. The radiated light is detected with the detector 30, which is described later.

The light source 20 does not have to irradiate excitation light to all the fluorescent substance F contained in the sample S kept in the sample container 10. The excitation light can be irradiated to at least some of the fluorescent substance F.

In the present embodiment, excitation light emitted from the light source 20 reaches a part of the area 100 of the sample container 10. The excitation light that has reached the part of the area 100 of the sample container 10 is partially absorbed by the fluorescent substance F in the neighborhood area of the part of the area 100 of the sample container 10.

### <Detector 30>

The detector 30 is a device that detects the radiated light emitted from the fluorescent substance F depending on excitation light. For example, photomultiplier tubes, silicon photodiodes, and avalanche photodiodes are used as the detector 30. A photomultiplier tube is used as the detector 30 in the present embodiment.

Radiated light entered to the photomultiplier tube is gradually multiplied by repeating emission of secondary electrons with a plurality of dinodes within the tube, which results in an ejection as electric charge pulses from the anode. A signal containing these electric charge pulses (detection signal D1) is detected, and accordingly, intensity of detection signal D1 is measured.

A location of the detector 30 is not particularly limited as long as the excitation light could not be detected. That is, the location of the detector 30 may be anywhere as long as it is not be on the path or on the extended line of the path along which the excitation light travels.

### <Controlling Device 40>

The controlling device 40 is a device that controls intensity of radiated light that the fluorescent substance F emits. The controlling device 40 is located on the path from the sample container 10 to the detector 30, along which the radiated light travels. The controlling device 40 includes a light reducer 400 and the controller 401.

The light reducer 400 is provided for reducing intensity of the radiated light. The light reducer 400 is located on the path (optical path) from the sample container to the detector 30, along which radiated light travels. That is, the foregoing detector 30 detects the radiated light transmitted through the light reducer 400.

The light reducer 400 is, in the present embodiment, one neutral density filter selected from a plurality of neutral density filters with a certain optical density (the neutral density filter is described later in detail).

The controller 401 controls the light reducer 400 so as to change the intensity of the radiated light transmitted through the light reducer 400. In the present embodiment, the controller 401 controls neutral density filters such that a specified neutral density filter is appropriately selected from a plurality of neutral density filters having different optical densities and applied.

One of the two neutral density filters, F₀ or F₁, having optical density 2 and 4 respectively, is used for the light reducer 400 of the present embodiment. The controller 401 control the neutral density filters such that either of the foregoing neutral density filters, or neither one of these is applied.

The neutral density filter is used as the light reducer 400 in the present embodiment; however, the light reducer 400 is not limited to the neutral density filter as long as intensity of the radiated light can be reduced.

Another example of the light reducer 400 is a plurality of dichroic mirrors which reflect or transmit different ranges of wavelength of light. In this case, the controller 401 can control the intensity of the radiated light transmitted through the dichroic mirror by applying one of a plurality of dichroic mirrors.

The dichroic mirror of this example is located on the same position as the foregoing neutral density filter. With such light reducer 400, intensity of the radiated light can also be reduced.

Furthermore, another example of the light reducer 400 is a stop with an opening. In this case, the controller 401 can control the intensity of the radiated light passing through the opening by controlling the diameter of the opening.

The stop of the foregoing example is located on the same position as the foregoing neutral density filter. With such light reducer 400, the intensity of the radiated light can also be reduced.

Furthermore, another example of the light reducer 400 is a lens for shifting a focus. In this case, the controller 401 controls the intensity of the radiated light to travel into the detector 30 can be controlled by shifting the focus of radiated light.

The lens of the foregoing example is located on the same position as the foregoing neutral density filter. With such light reducer 400, the intensity of the radiated light can also be reduced.

### <Dispensing Device 50>

The dispensing device 50 is an apparatus for supplying the sample S to the sample container 10 so that the sample S is kept in the sample container 10.

The dispensing device 50 has a nozzle (not shown). The dispensing device 50 supplies the sample S by injecting the sample S through the nozzle into the sample container 10.

<Measurement Device 60a>

The measurement device 60a is a device for measuring the concentration of the fluorescent substance F based on the detection signal D1 by the detector 30. The measurement device 60a of the present embodiment the foregoing controlling device 40, the dispensing device 50, and the washing device 70. The measurement device 60a is described later in detail.

### <Washing Device 70>

The washing device 70 is provided for washing the sample container 10 after the measurement of the concentration. The washing device 70 is a device capable of supplying the sample container 10 with washing liquid with which the sample container 10 is washed.

The washing device 70 includes a tank for storing washing liquid and a pump for injecting and draining the washing liquid, which are not shown in the figures.

### <<Analog Process and Digital Process>>

Analog process and digital process are exemplified as a process for measuring the concentration of the fluorescent substance F based on the detection signal D1 by the detector 30.

As is described hereafter, the measurement device 60a of the present embodiment performs a measurement process using a combination of the analog process and the digital process. These are described below and the detailed description of the measurement device 60a follows.

In the analog process, the detection signal D1 is treated as an analog current signal. A total amount of fluorescence in a certain measurement period is measured based on the analog current signal in the measurement period. Furthermore, based on the total amount of measured fluorescence, the concentration of the fluorescent substance F is determined with reference to a calibration curve for the analog measurement, which is made in advance using standard samples with known concentrations.

The analog process is effective when an enormous number of charge pulses is contained in the detection signal D1, or when some of the charge pulses are superimposed. That is, the analog process is effective for the measurement of a high concentration of the fluorescent substance F.

In the digital process, charge pulses are treated as every single discrete pulse. A counting circuit counts the charge pulses in the digital process. Furthermore, based on the counted charge pulses, the concentration of the fluorescent substance F is determined with reference to a calibration curve for the digital measurement, which is made in advance using standard samples with known concentrations.

The digital process is effective when charge pulses contained in the detection signal D1 are discrete and the detected signal is weak. That is, the digital process is effective for the measurement of a low concentration of the fluorescent substance F.

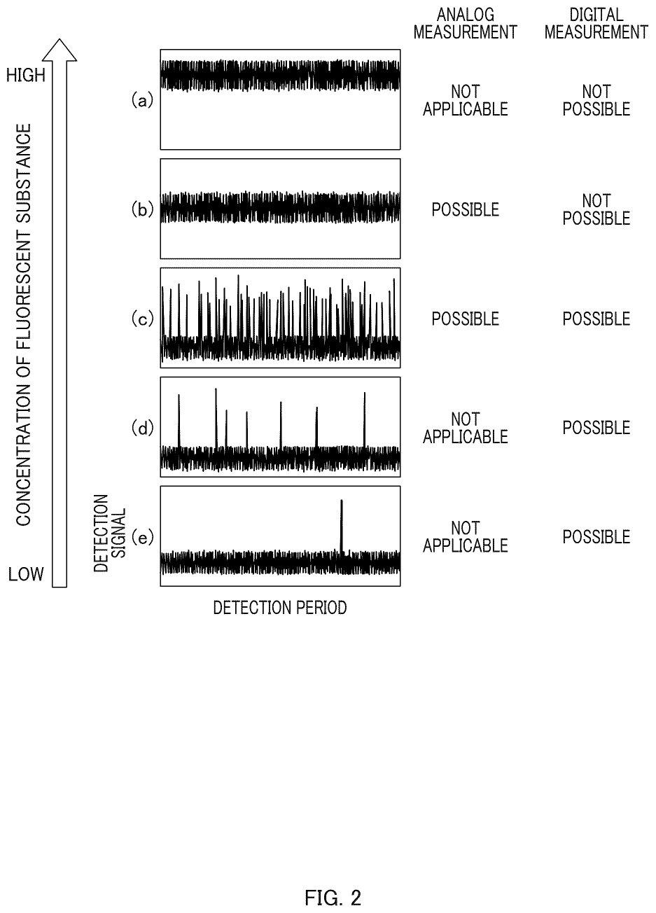

FIG. 2 illustrates an analog process and a digital process. FIG. 2 provides graphs (a) to (e), which show time-dependent transitions of the detection signal D1 by the detector 30. The graphs indicate the detection signal D1 detected from five kinds of the sample S having different concentrations of the fluorescent substance F, under the condition of a constant intensity of the excitation light.

The graph (a) corresponds to the highest concentration of the fluorescent substance F while the graph (e) corresponds to the lowest concentration of the fluorescent substance F. As can be seen by the graphs, the higher the concentration of the fluorescent substance F is, the greater the number of charge pulses contained in the detection signal D1 is.

In the graph (e) corresponds to the lowest concentration of the fluorescent substance F, the detection signal D1 contains one charge pulse, while the detection signal D1 in the graph (d) contains charge pulses which are discrete.

The measurement by the digital process is available when charge pulses are discrete and are not superimposed, as shown in graph (e) or (d). The analog measurement is not suitable for these cases since the analog current signal is weak and could be below the lower detectable limit.

Moreover, in graph (c), the number of charge pulses contained in the detection signal D1 is greater than the one in graph (d), and intervals of the charge pulses are dense. The charge pulses are partly superimposed, but almost discrete.

In such a case of graph (c), the analog measurement with a certain degree of accuracy can be performed in the analog process under the condition that the number of charge pulses is sufficient within the detectable degree of the analog current signal.

In such a case, also, the digital measurement with a certain degree of accuracy can be performed in the digital process, since charge pulses are almost discrete and each of the charge pulses is counted as a single pulse.

In graph (b), the number of charge pulses contained in the detection signal D1 is greater than the one in graph (c). Moreover, the charge pulses become further denser, and accordingly, some of the charge pulses are superimposed.

Some of charge pulses are superimposed as shown in graph (b), the superimposed charge pulses could possibly be counted as a single pulse in the digital process, and thus the digital measurement is impossible to perform.

In addition, in graph (a), the number of charge pulses contained in the detection signal D1 is greater than the one in graph (b), and the number of superimposed charge pulses is also greater. As a result, absolute values of the detection signal D1 are kept more during the detection period.

In such a case of graph (a), the analog measurement is not suitable since the analog current signal could be above the higher detectable limit.

### <Measurement Device 60a in Detail>

The detail of the measurement device 60a is described below. The following describes a hardware configuration of the measurement device 60a, and the description of function blocks implemented by the measurement device 60a follows.

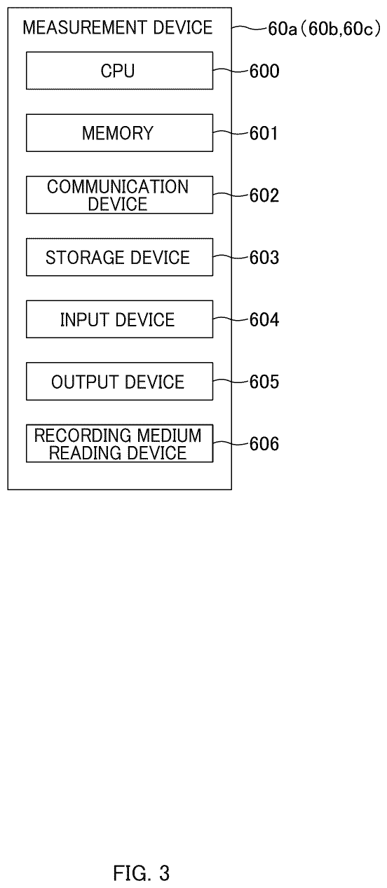

Hardware configuration of the measurement device 60a FIG. 3 illustrates a hardware configuration of a measurement device in the present embodiment. The measurement device 60a is a computer that comprises a CPU (Central Processing Unit) 600, a memory 601, a communication device 602, a storage device 603, an input device 604, an output device 605, and a recording medium-reading device 606.

### [CPU 600]

The CPU 600 implements various functions of the measurement device 60a by executing information processing programs stored in the memory 601 and the storage device 603.

### [Memory 601]

The memory 601 is, for example, a RAM (Random-Access Memory), and is used as a temporary storage area for various programs, data, and the like.

### [Communication Device 602]

The communication device 602 receives from and sends to other computers various programs and data via networks.

### [Storage Device 603]

The storage device 603 is a non-temporal (for example, nonvolatile) storage device that stores various data executed and processed by the CPU 600.

### [Input Device 604]

The input device 604 receives commands by a user and inputs of data, and includes input interfaces such as a keyboard and a touch sensor that detects a touched position on the touch panel display.

### [Output Device 605]

The output device 605 includes, for example, a display and a printer.

### [Recording Medium-Reading Device 606]

The recording medium-reading device 606 reads various data including information processing programs kept in recording mediums such as SD cards, DVDs, and CDROMs, and stores the data in the storage device 603.

### The Function Block of the Measurement Device 60a

The following describes the function blocks of the measurement device 60a.

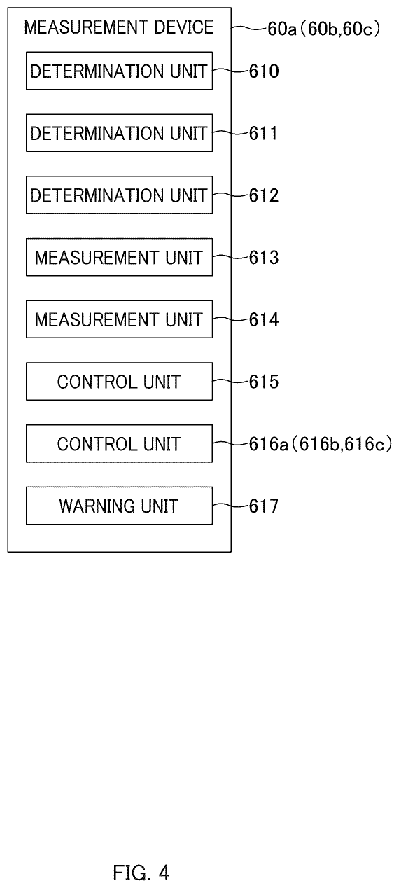

FIG. 4 illustrates a function block of the measurement device 60a of the present embodiment. The measurement device 60a implements a determination unit 610, 611, and 612, a measurement unit 613 and 614, a control unit 615 and 616a, and a warning unit 617. The following describes the respective units.

### [Determination Unit 610]

The determination unit 610 executes the determination process for determining whether the intensity I₀ of the detection signal D1 detected under the predetermined condition C₀ is within the predetermined range R₀. The details of the process executed by the determination unit 610, the condition C₀, and the range R₀ are described later.

### [Determination Unit 611]

The determination unit 611 executes the determination process for determining whether the intensity I₁ of the detection signal D1 detected under the predetermined condition C₁ is within the predetermined range R₁ when the intensity I₀ is determined to be lower than the lower limit L₀ of the range R₀ in the determination process executed by the foregoing determination unit 610. The details of the process executed by the determination unit 611, the condition C₁, and the range R₁ are described later.

### [Determination Unit 612]

The determination unit 612 executes the determination process for determining whether the intensity I₂ of the detection signal D1 detected under the predetermined condition C₂ is within the predetermined range R₂ when the intensity I₁ is determined to be lower than the lower limit L₁ of the range R₁ in the determination process executed by the foregoing determination unit 611. The details of the process executed by the determination unit 612, the condition C₂, and the range R₂ are described later.

### [Measurement Unit 613]

When it is determined as a result of the processes by the determination units 610 to 612 that the analog process is to be applied, the measurement unit 613 measures the concentration by the analog process. The detail of the process executed by the measurement unit 613 is described later.

### [Measurement Unit 614]

When it is determined as a result of the process by the determination unit 612 that the digital process is to be applied, the measurement unit 614 measures the concentration by the digital process. The detail of the process executed by the measurement unit 614 is described later.

The measurement unit 614 executes the digital measurement, in which the measurement process of the concentration is performed, when the intensity I₂ is determined to be lower than the lower limit L₂ of the range R₂, in the determination process by the determination unit 612.

### [Control Unit 615]

The control unit 615 controls the washing device 70. It is controlled depending on which has been executed in the concentration measurement, the analog process or the digital process.

When the analog process has been executed in the measurement of the concentration, the control unit 615 controls the washing device 70 such that the sample container 10 is washed for the predetermined washing time T_{w1}.

When the digital process has been executed in the measurement of the concentration, the control unit 615 controls the washing device 70 such that the sample container 10 is washed for the predetermined washing time T_{w2}.

The washing time T_{w1} is set longer than the washing time T_{w2}. The reason why such setting is advantageous is described hereafter.

Generally, the higher the concentration of the fluorescent substance F in the sample S is, the longer the required time is to wash the sample container 10 after the execution of measuring the concentration.

According to the foregoing processes by the determination units 610 to 612, when the digital process is executed, the intensity of radiated light directly emitted from the sample S (radiated light before transmitting the neutral density filter) is lower than the intensity when the analog process is executed.

That is, when the digital process is executed, the concentration of the fluorescent substance F contained in the sample S is lower than the concentration when the analog process is executed.

Accordingly, when the analog process is executed, the longer washing time (washing time T_{w1}) is required than when digital process is executed. In other words, when the digital process is executed, the shorter washing time (washing time T_{w2}) is sufficient than when the analog process is executed.

[Control Unit 616a]

The control unit 616a controls the controlling device 40 to apply one of the conditions C₀, C₁, and C₂ or switch between them depending on the foregoing process by the determination units 610 to 612. The detail of the processing executed by the control unit 616a is described later.

The control unit 616a controls the controlling device 40 so that the condition C₀ is set for the determination process of the determination unit 610. In this case of the present embodiment, the controlling device 40 adopts the neutral density filter F₀ having the optical density 4. The intensity of the detection signal D1 thereby becomes the intensity I₀.

Furthermore, the control unit 616a controls the controlling device 40 so that the condition C₁ is set for the determination process of the determination unit 611. In this case of the present embodiment, the controlling device 40 adopts the neutral density filter F₁ having the optical density 2. The intensity of the detection signal D1 thereby becomes the intensity I₁.

Moreover, the control unit 616a controls the controlling device 40 so that the condition C₂ is set for the determination process of the determination unit 612. In this case of the present embodiment, the controlling device 40 does not adopt the neutral density filter. The intensity of the detection signal D1 thereby becomes the intensity I₂.

### [Warning Unit 617]

The warning unit 617 issues a warning in the measurement of the concentration, when it is determined that the analog process and the digital process are both impossible. The detail of the processing executed by the warning unit 617 is described later.

<<The Process Executed by the Measurement Device 60a>>

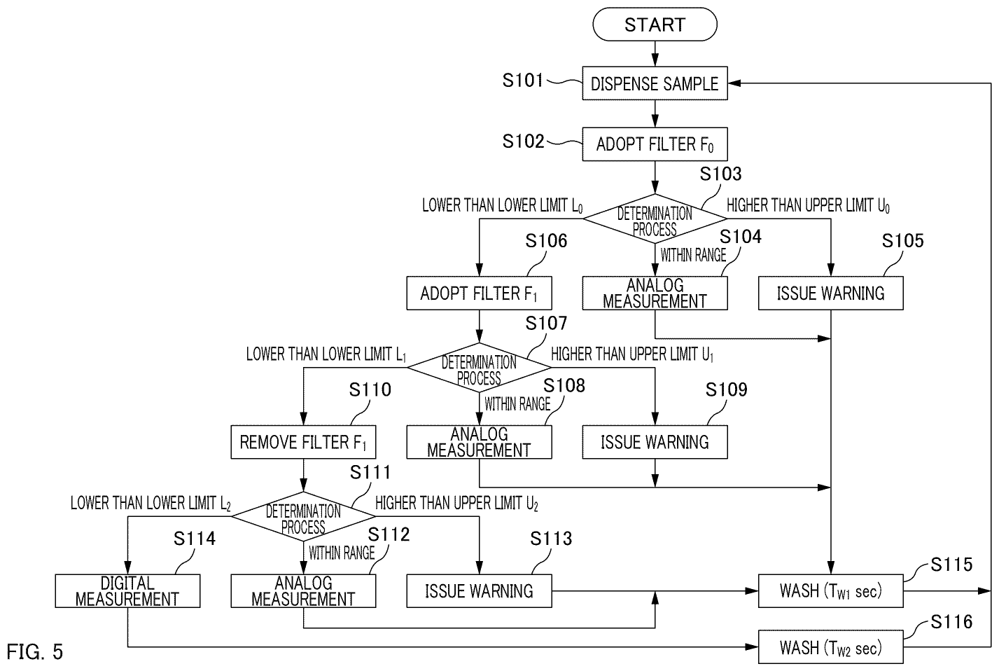

FIG. 5 illustrates a flowchart of a process executed by the measurement device 60a. The following describes the process from the step that the concentration of the fluorescent substance F contained in the sample S is measured to the step that the sample container 10 is washed after the measurement, with reference to the flowchart.

### [Step S101]

In step S101, the sample S is dispensed by the dispensing device 50 (FIG. 1). The dispensing device 50 gives out the sample S from the nozzle (not shown) and puts it into the sample container 10.

### [Step S102]

In step S102, the controlling device 40 adopts the neutral density filter F₀. The neutral density filter F₀ has the optical density of 4.

### [Step S103]

In step S103, the determination unit 610 executes the first determination process. The determination unit 610 determines in the step whether the intensity I₀ of the detection signal D1, detected under the condition (the condition C₀) that the neutral density filter F₀ is applied, is lower than the lower limit L₀ of the predetermined range R₀, is within the predetermined range R₀, or is higher than the upper limit U₀ of the range R₀.

In the present embodiment, the duration Ta of the determination process (the period during which the detection signal is detected) is 0.5 seconds. Note that the duration Ta is not particularly limited, and may freely be set by a user.

In this case, the condition C₀ is not limited as long as the intensity of the detection signal D1 is lower than that in the case that the light reducer 400 is not provided (that is, the case that the detector 30 directly detects radiated light).

Additionally, the lower limit L₀ of the range R₀ may be, for example, set equal to or higher than the lower limit value Lₐ of intensity for which the analog process can be adopted. The upper limit U₀ may be, for example, set equal to or lower than and close to the upper limit value Uₐ of the intensity for which the analog process can be adopted.

### [Step S104]

Proceed to step S104 if the determination unit determines in step S103 that the intensity I₀ is within the range R₀. In step S104, the measurement unit 613, maintaining the condition that the filter F₀ is applied (the condition C₀), executes the analog measurement, in which the measurement process of the concentration is performed.

In the present embodiment, the duration Tₐₘ of the measurement process (the period during which the detection signal is detected) is 2.0 seconds. The duration Tₐₘ is not particularly limited, and may freely be set by a user.

### [Step S105]

Proceed to step S105 if the determination unit determines in step S103 that the intensity I₀ is higher than the upper limit U₀. In step S105, the warning unit 617 issues a warning that neither the analog process nor the digital process is possible. Then, the warning unit 617 also displays a message on the screen of the output device 605 (FIG. 3), such as “MEASUREMENT NOT POSSIBLE: concentration exceeds upper limit of measurement”.

### [Step S106]

Proceed to step S106 if the determination unit 610 determines in step S103 that the intensity I₀ is lower than the lower limit L₀. In step S106, the controlling device 40 adopts the neutral density filter F₁. The neutral density filter F₁ has the optical density of 2.

That is, the intensity of the detection signal D1 through the neutral density filter F₁ is higher than that through the neutral density filter F₀ having the optical density of 4, which is used in the determination process in step S103.

### [Step S107]

In step S107 followed by step S106, the determination unit 1 executes the second determination process. The determination unit 611 determines in this step whether the intensity I₁ of the detection signal D1, detected under the condition that the neutral density filter F₁ is adopted (the condition C₁), is lower than the lower limit L₁ of the predetermined range R₁, within the predetermined range R₁, or higher than the upper limit U₁ of the range R₁.

In this case, the intensity of the detection signal D1 under the condition C₁ is higher than the one under the foregoing condition C₀. Furthermore, the range R₁ is the same as the foregoing range R₀ in the present embodiment. Note that the range R₁ is not limited to this range, but may be set as a range different from the range R₀.

In the present embodiment, the duration Ta in which the determination process is executed (the period during which excitation light is irradiated) is 0.5 seconds.

### [Step S108]

Proceed to step S108 if the determination unit 611 determines in step S107 that the intensity I₁ is within the range R₁. In step S108, the measurement unit 613, maintaining the condition that the neutral density filter F₁ is adopted (the condition C₁), executes the analog process for the intensity I₁ of the detection signal D1, in which the measurement process for measuring the concentration of the fluorescent substance F contained in the sample S is performed.

In the present embodiment, the duration Tₐₘ in which the measurement process is executed (the period during which the excitation light is irradiated) 2.0 seconds.

### [Step S109]

Proceed to step S109 if the determination unit 611 determines in step S107 that the intensity I₁ is higher than the upper limit U₁. In step S109, the warning unit 617 issues a warning that neither the analog process nor the digital process is possible. That is, the warning unit 617 executes the same process as the one in step S105.

### [Step S110]

Proceed to step S110 if the determination unit 611 determines in step S107 that the intensity I₁ is lower than the lower limit L₁. In step S110, the controlling device 40 removes the neutral density filter F₁ so that the neutral density filter is not applied.

### [Step S111]

In step S111 following step S110, the determination unit 612 executes the third determination process. The determination unit 612 determines in this step whether the intensity I₂ of the detection signal D1, detected under the condition that the neutral density filter is not adopted (the condition C₂), is lower than the lower limit L₂ of the predetermined range R₂, within the predetermined range R₂, or higher than the upper limit U₂ of the range R₂.

In this case, the intensity of the detection signal D1 under the condition C₂ is higher than the one under the foregoing condition C₁. Furthermore, the lower limit L₂ of the range R₂ may be, for example, set equal to or higher than the lower limit value of intensity for which the analog process can be adopted and equal to or lower than the upper limit value of intensity for which the digital process can be adopted. The upper limit U₂ may be, for example, the same value as the upper limit U₂.

In the present embodiment, the duration T_{d} in which the determination process is executed (the period during which the excitation light is irradiated) is 0.5 seconds.

### [Step S112]

Proceed to step S112 if the determination unit 612 determines in step S111 that the intensity I₂ is within the range R₂. In step S112, the measurement unit 613, maintaining the condition that the neutral density filter is not applied (the condition C₂), executes the analog process for the intensity I₂ of the detection signal D1, in which the measurement process for measuring the concentration of the fluorescent substance F contained in the sample S is performed.

In the present embodiment, the duration Tₐₘ in which the measurement process is executed (the period during which excitation light is irradiated) 2.0 seconds.

### [Step S113]

Proceed to step S113 if the determination unit 612 determines in step S111 that the intensity I₂ is higher than the upper limit U₂. In step S113, the warning unit 617 issues a warning that neither the analog process nor the digital process is possible.

### [Step S114]

Proceed to step S114 if the determination unit 612 determines in step S111 that the intensity I₂ is lower than the lower limit L₂. In step S114, the measurement unit 614, maintaining the condition that the neutral density filter is not applied (the condition C₂), executes the digital process, in which the measurement process for measuring the concentration of the fluorescent substance F contained in the sample S is performed.

In the present embodiment, the duration T_{dm} in which the measurement process is executed (the period during which the excitation light is irradiated) is 18 seconds.

### [Step S115]

Step S115 follows the foregoing steps S104, S105, S108, S109, S112, and S113. Either measurement by the analog process is executed, or a warning that the measurement is impossible to execute is issued in the steps S104, S105, S108, S109, S112, and S113.

The control unit 615 controls the washing device 70 in step S115 such that the washing liquid flows into the sample container 10 for the washing time T_{w1}.

### [Step S116]

Step 116 follows step S114. In step S114, the measurement by the digital process has been executed.

The control unit 615 controls the washing device 70 in step S116 such that the washing liquid flows into the sample container 10 for the washing time T_{w2}. As described, the washing time T_{w1} is set longer than the washing time T_{w2}.

The above describes the process from which the measurement of the sample S is executed and to which the sample container 10 is washed. After step S115 or step 116 terminates, it returns to step S101, and the process is executed for another sample to be measured.

According to the process by the measurement device 60a as described above, it is possible to wash the sample container 10 for the washing time, depending on the concentration of the fluorescent substance F.

Furthermore, since the washing time T_{w1} for the analog process is longer than the washing time T_{w2} for the digital process in the present embodiment, more sufficient washing time can be spent on the sample container 10.

In the foregoing process, the duration T_{d} (0.5 seconds) during which the determination process is executed in steps S103, S107, and S111 is shorter than the duration Tₐₘ (2.0 seconds) during which the analog process is executed in steps S104, S108, and S112.

Moreover, the process executed by the measurement device 60a includes three determination processes, steps S103, S107, and S111; however, the number of the determination processes is not limited to three.

For example, two determination processes, steps S107 and S111, may be executed by omitting steps S102 to S104.

Alternatively, four or more determination processes may be executed. In this case, the n neutral density filters of F₀ to Fₙ₋₁ (n is an integer equal to or greater than 4) having different optical densities are used when the light reducer 400 is neutral density filters.

In the case above, using neutral density filters in descending order of the optical density, starting with the neutral density filter F₀ having the highest optical density, the n determination processes may be executed in the same way as the present embodiment.

In such a case above, a boundary value of the concentration between the case for the analog process and the case for the digital process becomes more appropriate by increasing the number of the determination processes.

### <<Correspondence>>

The determination unit 611 corresponds to “the first determination unit”, the condition C₁ corresponds to “the first condition”, the intensity I₁ corresponds to “the first value of intensity”, the range R₁ corresponds to “the first range”, and the determination process executed by the determination unit 611 corresponds to “the first determination process”.

The determination unit 612 corresponds to “the second determination unit”, the condition C₂ corresponds to “the second condition”, the intensity I₂ corresponds to “the second value of intensity”, the range R₂ corresponds to “the second range”, and the determination process executed by the determination unit 612 corresponds to “the second determination process”.

The measurement unit 613 corresponds to “the first measurement unit” and the measurement process (the analog process) executed by the measurement unit 613 corresponds to “the first measurement process”.

The measurement unit 614 corresponds to “the second measurement unit” and the measurement process (the digital process) executed by the measurement unit 614 corresponds to “the second measurement process”.

The control unit 615 corresponds to the “the first control unit”, the washing time T_{w1} corresponds to “the first washing time period”, and the washing time T_{w2} corresponds to “the second washing time period”. The control unit 616a corresponds to “the second control unit”. The duration T_{d} corresponds to “the first time period”, and the duration Tₐₘ corresponds to “the second time period”.

### The Second Embodiment

The measurement system 1a of the first embodiment is an embodiment that the controlling device 40 is used for setting respective conditions (the conditions C₀, C₁, and C₂) when the determination process is executed by the determination units 610 to 612.

Specifically, the controlling device 40 controls the detected intensity of radiated light by controlling the case of applying the neutral density filter F₀ or F₁, or the case of applying no neutral density filter.

However, the control for setting the conditions C₀, C₁, and C₂ is not limited to the above embodiment. The present embodiment describes another embodiment for setting the conditions C₀, C₁, and C₂.

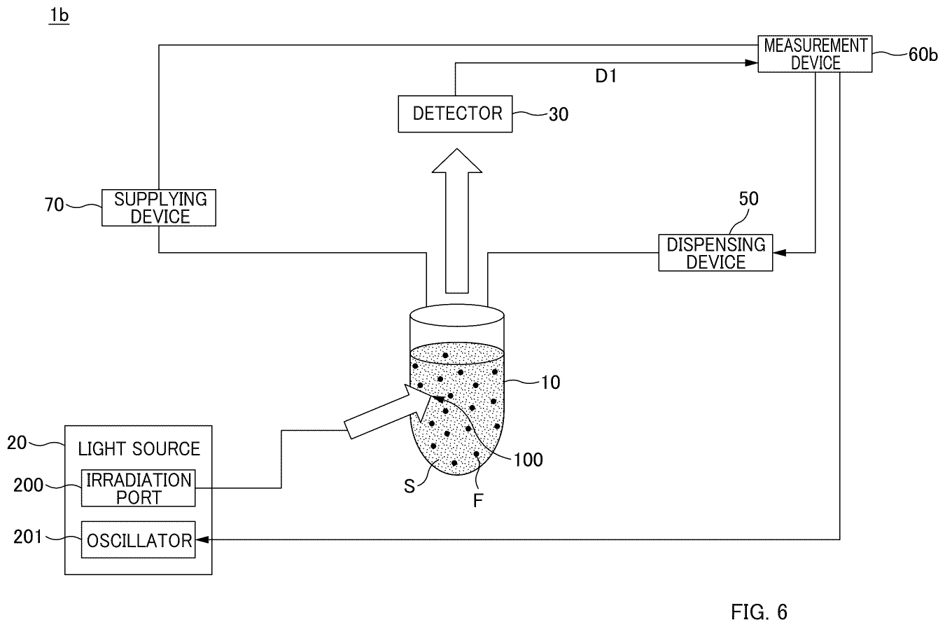

FIG. 6 illustrates a measurement system 1b of the present embodiment. The measurement system 1b differs from that in the first embodiment in that the measurement device 60b controls an output of the light source 20.

In the measurement system 1b, the measurement device 60b includes the control unit 616b (that corresponds to “the third control unit”) instead of the control unit 616a of the first embodiment.

The control unit 616b controls the light source 20 such that the intensity of the detection signal D1 becomes the intensity I₂, instead of, for example, the process by the control unit 616a in step S106 in FIG. 5. The same applies to the determination process by the control unit 616a in steps S102 and S110.

For such control by the control unit 616b, the predetermined conditions C₀, C₁, and C₂ can also be set.

### The Third Embodiment

The present embodiment describes another embodiment for setting the conditions C₀, C₁, and C₂.

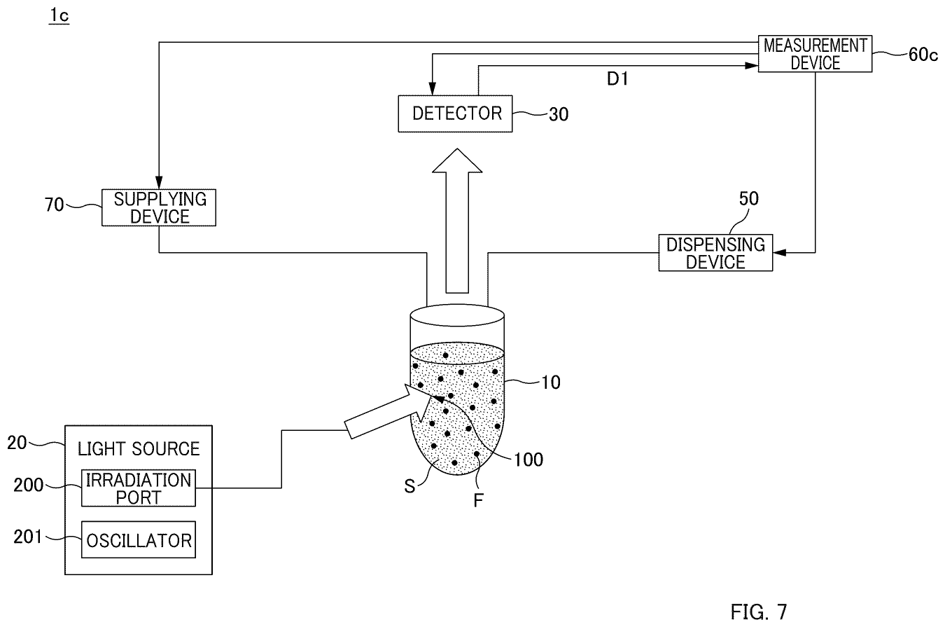

FIG. 7 illustrates a measurement system 1c of the present embodiment. The measurement system 1c differs from that in the first embodiment in that the measurement device 60c controls an output of the detector 30.

In the measurement system 1c of the present embodiment, the measurement device 60c includes the control unit 616c (that corresponds to “the fourth control unit”) instead of the control unit 616a of the first embodiment.

The control unit 616c controls the detector 30 such that the intensity of the detection signal D1 becomes the intensity I₂, instead of, for example, the process by the control unit 616a in step S106 in FIG. 5. Specifically, the control unit 616c enhances sensitivity of the detector 30 so that the intensity of the detection signal D1 becomes I₂.

The same applies to the determination process by the control unit 616a in steps S102 and S110.

For such control of the control unit 616c, the predetermined conditions C₀, C₁, and C₂ can also be set.

### The Fourth Embodiment

The present embodiment is described regarding the measurement system 1d including a sample container 801 different from that in the first embodiment.

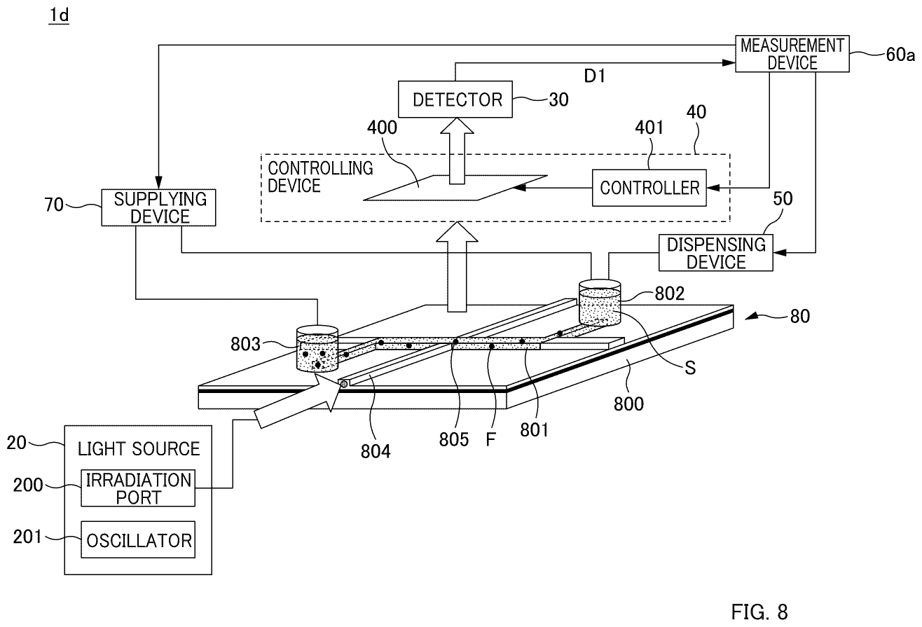

FIG. 8 illustrates a measurement system 1d of the present embodiment. The measurement system 1d differs from that in the first embodiment in that a chip 80 is included instead of the sample container 10 (FIG. 1).

The chip 80 of the present embodiment is made of a silicon substrate 800. The sample container 801, an inlet 802, an outlet 803, and an optical waveguide 804 are provided on one side of the silicon substrate 800.

The sample container 801 of the present embodiment is a hollowspace through which the sample S passes in the measurement of the concentration.

The sample container 801 of the present embodiment is a hollow channel. The sample container 801 is formed so as to flow the sample S through the channel in the measurement of the concentration.

The inlet 802 is provided to supply the sample S or the washing liquid from one end of the sample container 801 into the sample container 801. The inlet 802 is provided at one side of the sample container 801. The inlet 802 of the present embodiment is cylindrical-shaped, and communicates with the sample container 801 by the bottom of the inlet 802 and one side of the sample container 801 combining with each other.

In the present embodiment, the dispensing device 50 supplies the sample S to the sample container 10 by injecting the sample S into the inlet 802 through the nozzle.

Furthermore, the washing device 70 supplies the washing liquid to the sample container 801 by injecting the washing liquid into the inlet 802.

The outlet 803 is provided to discharge the sample S or the washing liquid from the opposing side of the sample container 801. The outlet 803 is provided at the other side of the sample container 801. The outlet 803 of the present embodiment is cylindrical-shaped, and communicates with the sample container 801 by the bottom of the outlet 803 and the other side of the sample container 801 combining with each other.

The washing device 70 discharges the washing liquid from the outlet 803 in the present embodiment. The washing liquid flows through the sample container 801 that is washed thereby.

The optical waveguide 804 is formed so as to lead excitation light (described later) from the light source 20 to the sample container 801. The optical waveguide 804 is filled with a transparent medium. The optical waveguide 804 is located to intersect the sample container 801.

The optical waveguide 804 of the present embodiment has the shape of a straight line, and is located to intersect orthogonally the sample container 801 at a location 805 where the optical waveguide 804 intersects the sample container 801.

The excitation light emitted from the light source 20 enters into the transparent medium from one side of the optical waveguide 804, and travels in the optical waveguide 804. Accordingly, the excitation light is irradiated to the fluorescent substance F close to the location 805 in the sample container 801.

According to such a configuration of the sample container 801, it is also possible to wash the sample container for the washing time depending on the concentration of the fluorescent substance F.

### SUMMARY

The measurement systems 1a, 1b, 1c, and 1d of embodiments described above comprise the light source 20 for irradiating excitation light to the fluorescent substance F kept in the sample containers 10 and 801 which contain the sample S comprising the fluorescent substance F, the detector 30, for detecting radiated light emitted from fluorescent substance F depending on the excitation light, the measurement devices 60a, 60b, and 60c for measuring the concentration of the fluorescent substance F based on the detection signal D1 detected by the detector 30, and the washing device 70 for supplying washing liquid for washing the sample container to the sample container, and the measurement devices 60a, 60b, and 60c comprise the determination unit 611 for executing the determination process, the determination process determining whether the intensity I₁ of the detection signal D1 detected under the condition C₁ is within the range R₁, the measurement unit 613 for executing the analog measurement, in which the measurement process measuring the concentration of the fluorescent substance F contained in the sample S is performed when the intensity I₁ is within the range R₁, the measurement unit 614 for executing the digital measurement, in which the measurement s measuring the concentration of the fluorescent substance F contained in the sample S is performed when the intensity I₁ is determined to be lower than the lower limit L₁ of the range R₁, and the control unit 615 for controlling the washing device 70 such that the sample containers 10 and 801 are washed for the washing time period T_{w1} when the analog process is performed and the sample containers 10 and 801 are washed for the washing time period T_{w2} when the digital measurement is performed.

According to such a configuration, by the process of the determination unit 611, an appropriate process of the analog process or the digital process is selected depending on the concentration of the fluorescent substance F. In addition, the sample container 10 and 801 are washed for the washing time depending on the process for the measurement of the concentration. That is, it possible to wash sample containers 10 and 801 for an appropriate washing time, depending on the concentration of the fluorescent substance F.

In the measurement systems 1a, 1b, 1c, and 1d, the measurement devices 60a, 60b, and 60c execute the digital measurement when the intensity I₂ is determined to be lower than the lower limit L₂ of the range R₂, with the determination unit 612 for executing the determination process, the determination process determining whether the intensity I₂ of the detection signal D1 detected under the condition C₂ under which the intensity of the detection signal D1 is higher than that the condition C₁ is within the range R₂. According to such a configuration, by the process of the determination unit 612, an accuracy of the measurement enhances since an appropriate process of the analog process or the digital process is selected depending on the concentration of the fluorescent substance F.

In measurement systems 1a, 1b, 1c, and 1d, the washing time T_{w2} is shorter than the washing time T_{w1}. According to such a configuration, the efficiency of the measurement and the washing process executed by the measurement systems 1a, 1b, 1c, and 1d increase, and accordingly, the time consumed for the entire process is shortened.

The measurement systems 1a and 1d of the first and the fourth embodiments comprise the controlling device 40 for controlling intensity of the radiated light located on a path that light travels from the sample containers 10 and 801 to the detector 30, and the measurement device 60a comprises the control unit 616a for controlling the controlling device 40 such that the intensity of the detection signal D1 is the intensity I₂ when the intensity I₁ is determined less than the lower limit L₁ of the range R₁. According to such a configuration, an accuracy of the measurement enhances since variations in the intensity I₂ is reduced.

In the measurement systems 1a and 1d of the first and the fourth embodiments, the controlling device 40 comprises the sample containers 10 and 801, the light reducer 400 located between the controlling device 40 and the detector 30, and the controller 401 for controlling the light reducer 400 such that intensity of the radiated light transmitting the light reducer 400 changes. According to such a configuration, an accuracy of the measurement enhances since variations in the intensity I₂ is further reduced.

In the measurement system 1b of the second embodiment, the measurement device 60b comprises the control unit 616b for controlling the light source 20 such that the intensity of the detection signal D1 is the intensity I₂ when the intensity I₁ is determined to be lower than the lower limit L₁ of the range R₁. According to such a configuration, the configuration of the measurement system 1b is simplified since it is sufficient to control an output of the light source 20.

In the measurement system 1c of the third embodiment, the measurement device 60c comprises the control unit 616c for controlling the detector 30 such that the intensity of the detection signal D1 is the intensity I₂ when the value of intensity I₁ is determined to be lower than the lower limit of the range R₁. According to such a configuration, the configuration of the measurement system 1c is simplified since it is sufficient to control sensitivity of the detector 30.

In the measurement systems 1a, 1b, 1c, and 1d of embodiments, the duration T_{d} for executing the determination process is shorter than the duration Tₐₘ for executing the analog process. According to such a configuration, the time consumed for the entire process is shortened, maintaining an accuracy of the measurement.

The measurement system 1a, 1b, 1c, and 1d of embodiments comprises the warning unit 617 issuing a warning when the intensity I₁ is determined to be higher than the upper limit U₁ of the range R₁. According to such a configuration, a user can recognize that neither the analog process nor the digital process is possible to perform for measuring the concentration of the fluorescent substance F.

The measurement method of embodiments executed by the measurement systems 1a, 1b, 1c, and 1d comprise the light source 20 for irradiating excitation light to the fluorescent substance F kept in the sample containers 10 and 801 which contain the sample comprising the fluorescent substance F, the detector 30 for detecting radiated light emitted from the fluorescent substance F depending on the excitation light, the measurement devices 60a, 60b, and 60c for measuring the concentration of the fluorescent substance F based on the detection signal D1 detected by the detector 30, and the washing device 70 for supplying washing liquid for washing the sample containers 10 and 801 to the sample containers, and the measurement device 60a, 60b, and 60c comprises a step for executing the determination process, the determination process determining whether the intensity I₁ of the detection signal D1 detected under the condition C1 is within the range R₁, a step for executing an analog measurement, in which the measurement process measuring the concentration of the fluorescent substance F contained in the sample S is performed when the intensity I₁ is within the range R₁, a step for executing the digital measurement, in which the measurement process measuring the concentration of the fluorescent substance F contained in the sample S is performed when the intensity I₁ is determined to be lower than the lower limit L₁ of the range R₁, and a step for controlling the washing device 70 such that the sample containers 10 and 801 are washed for the washing time T_{w1} when the analog process is executed and the sample containers 10 and 801 are washed for washing time T_{w2} when the digital process is executed.

According to such a method, by the process of the determination units 611 and 612, an appropriate process of the analog process or the digital process is selected depending on the concentration of the fluorescent substance F, and the sample containers 10 and 801 are washed for the washing time according to the process for measuring the concentration. That is, it is possible to wash the sample containers 10 and 801 for the washing time depending on the concentration of the fluorescent substance F.

### DESCRIPTION OF THE REFERENCE NUMERALS

a measurement system 1a, 1b, 1c, 1d
a sample container 10, 801
a silicon substrate 800
an inlet 802
an outlet 803
an optical waveguide 804
a light source 20
a detector 30
a controlling device 40
a light reducer 400
a controller 401
a dispensing device 50
a measurement device 60a, 60b, 60c
a CPU 600
a memory 601
a communication device 602
a storage device 603
an input device 604
an output device 605
a recording medium-reading device 606
a determination unit 610, 611, and 612
a measurement unit 613, 614
a control unit 615, 616a, 616b, 616c
a warning unit 617
a washing device 70

1. A measurement system comprising:
a light source configured to irradiate excitation light to a fluorescent substance kept in a sample container, the sample container containing a sample comprising the fluorescent substance;
a detector configured to detect radiated light emitted from the fluorescent substance depending on the excitation light;
a measurement device configured to measure a concentration of the fluorescent substance based on a detection signal detected by the detector; and
a washing device configured to supply washing liquid for washing the sample container to the sample container;
the measurement device comprising:
a first determination unit configured to execute a first determination process, the first determination process determining whether a first value of intensity of the detection signal detected under a first condition is within a first range;
a first measurement unit configured to execute an analog measurement, in which a first measurement process measuring a concentration of the fluorescent substance contained in the sample is performed when the first value of intensity is within the first range;
a second measurement unit configured to execute a digital measurement, in which a second measurement process measuring a concentration of the fluorescent substance contained in the sample is performed when the first value of intensity is determined to be lower than a lower limit of the first range; and
a first control unit configured to control the washing device such that the sample container is washed for a first washing time period when the first measurement process is performed and the sample container is washed for a second washing time period when the second measurement process is performed.

2. The measurement system according to claim 1, wherein the measurement device comprises:
a second determination unit configured to execute a second determination process, the second determination process determining whether a second value of intensity of the detection signal detected under a second condition under which the value of intensity is higher than that under the first condition is within a second range when the first value of intensity is determined to be lower than the lower limit of the first range; and wherein
the second measurement unit configured to execute the digital measurement, in which the second measurement process is performed when the second value of intensity is determined to be lower than a lower limit of a second range.

3. The measurement system according to claim 1, wherein
the second washing time period is shorter than the first washing time period.

4. The measurement system according to claim 2, further comprising
a controlling device configured to control intensity of the radiated light located on a path that light travels from the light source to the detector; and wherein
the measurement device comprises a second control unit configured to control the controlling device such that the value of intensity of the detection signal is the second value of intensity when the first value of intensity is determined less than the lower limit of the first range.

5. The measurement system according to claim 4, wherein the controlling device further comprises:
a light reducer located between the light source and the detector; and
a controller configured to control the light reducer such that intensity of the radiated light transmitting the light reducer changes.

6. The measurement system according to claim 2, wherein
the measurement device further comprises a third control unit configured to control the light source such that the value of intensity of the detection signal is the second value of intensity when the first value of intensity is determined to be lower than the lower limit of the first range.

7. The measurement system according to claim 2, wherein
the measurement device further comprises a fourth control unit configured to control the detector such that the value of intensity of the detection signal is the second value of intensity when the first value of intensity is determined to be lower than the lower limit of the first range.

8. The measurement system according to claim 1, wherein
a first time period for executing the first determination process is shorter than a second time period for executing the first measurement process.

9. The measurement system according to claim 8, further comprising
a warning unit issuing a warning when the first value of intensity is determined to be higher than the upper limit of the first range.

10. A measurement method executed by a measurement system, the measurement system comprising:
a light source configured to irradiate excitation light to a fluorescent substance kept in a sample container, the sample container containing a sample comprising the fluorescent substance;
a detector configured to detect radiated light emitted from the fluorescent substance depending on the excitation light;
a measurement device configured to measure a concentration of the fluorescent substance based on a detection signal detected by the detector; and
a washing device configured to supply washing liquid for washing the sample container to the sample container;
the measurement method comprising:
executing a first determination process, the determination process determining whether a first value of intensity of the detection signal detected under a first condition is within a first range;
executing an analog measurement, in which a first measurement process measuring a concentration of the fluorescent substance contained in the sample is performed when the first value of intensity is within the first range;
executing a digital measurement, in which a second measurement process measuring a concentration of the fluorescent substance contained in the sample is performed when the first value of intensity is determined to be lower than a lower limit of the first range; and
controlling the washing device such that the sample container is washed for a first washing time period when the first measurement process is executed and the sample container is washed for a second washing time period when the second measurement process is executed.
